(19) United States
(12) Patent Application Publication
(10) Pub. No.: US 2011/0003121 A1
(43) Pub. Date: Jan. 6, 2011

(54) Reflection-preventing film and display device

(76) Inventor: Kazuhiko Tsuda, Osaka (JP)

Correspondence Address: HARNESS, DICKEY & PIERCE, P.L.C., P.O. BOX 8910, RESTON, VA, 20195, US

(21) Appl. No.: 12/736,085

(22) PCT Filed: Feb. 4, 2009
(86) PCT No.: PCT/JP2009/051909

§ 371 Date: Sep. 9, 2010

(30) Foreign Application Priority Data
May 27, 2008 (JP) 2008-138458

(51) Int. Cl. B32B 3/00

(52) U.S. Cl. 428/156

(57) ABSTRACT

A reflection-preventing film is disclosed, which reduces reflection of light on the surface of a display device and reduces the influence of light reflecting inside the display device. The reflection-preventing film of at least one embodiment of the present invention is a reflection-preventing film having on its surface a fine uneven structure in which a width between adjacent top points is equal to or less than a visible wavelength, wherein a half-value angle of transmission scattering intensity distribution of light transmitted through overlapped two sheets of the reflection-preventing film is 1.0° or more.

### TECHNICAL FIELD

The present invention relates to a reflection-preventing film and a display device. More specifically, the present invention relates to a reflection-preventing film capable of reducing light reflectance, and a display device having the reflection-preventing film on its display surface.

### BACKGROUND ART

Flat panel display (FPD) technology has been greatly advanced, and large screen plasma TVs and liquid crystal TVs (LC-TV) having an FPD have become popular these days. FPDs are often used in bright places such as a living room in a normal house as is well exemplified by the application to TVs. Thus, good visibility of FPDs is required in not only dark places but bright places as well.

An FPD is a display device generally produced using a glass substrate. Since light reflects on the surface of the display device in bright places, the reflected light problematically hinders the view of images. In the case of conventional FPDs, as techniques to reduce the reflection on the surface, low reflection (LR) treatment and antiglare (AG) treatment have been performed. The LR treatment includes applying a resin having a refractive index of 1.5 or less on the surface of the display device, and controlling the thickness of the resin to be approximately ¼ the wavelength of light. In this manner, the reflection at the interface between air and the resin and the reflection at the interface between the resin and the substrate are superimposed to cancel each other, thereby reducing the reflectance.

However, since the reflectance of the reflection on the interface between air and the resin is generally different from that of the reflection on the interface between the resin and the substrate, the reflected lights do not completely cancel one another, and thus the reflection preventing effect is not sufficient. Therefore, in the case of the LR treatment only, the display surface still reflects surrounding light at a certain reflectance. As a result, image of light sources such as fluorescent lamp is reflected on the display, leading to hardly viewable display. For this reason, it is further necessary to perform AG treatment for forming an uneven structure on the surface of the display device so that the light is scattered and thus image of light sources such as fluorescent lamp is blurred.

Meanwhile, as a technology to improve visibility in bright places other than the LR treatment and the AG treatment, an increasing attention has been paid to moth-eye structures, which provide great reflection preventing effect without using the light interference technique. For forming the moth-eye structure on a surface of a product to which the reflection preventing treatment is performed, an uneven pattern at intervals of not more than a wavelength of light (for example, 400 μm or less), that is finer than the pattern to be formed by AG treatment, is arranged without any space therebetween so that changes of the refractive index at the border between the outside (air) and the film surface are artificially made sequential. As a result, the product with the moth-eye structure can transmits almost all light regardless of the refractive index interface so that almost all the light reflection on the surface of the object can be avoided (see, for example, Patent Document 1).

As the method for forming the moth-eye structure on the surface of the display device, a method including: firstly preparing a mold for forming a fine uneven pattern; forming a film for printing the uneven pattern on the surface of the display device; and then pressing the mold to a surface of the film to transfer the uneven pattern of the mold to the surface of the film (see, for example, Patent Documents 2, 3, and 5 to 7), or a method including forming a metal mask on the surface and then performing etching on the surface so as to form an uneven pattern on the surface (see, for example, Patent Document 4), or other methods may be exemplified. As a method for forming the uneven pattern on the mold, a method including anodization and etching, electron beam lithography, and other methods may be exemplified.

### [Patent Document 1]

Japanese Patent Publication No. 2001-517319

### [Patent Document 2]

Japanese Kokai Publication No. 2004-205990

### [Patent Document 3]

Japanese Kokai Publication No. 2004-287238

### [Patent Document 4]

Japanese Kokai Publication No. 2001-272505

### [Patent Document 5]

Japanese Kokai Publication No. 2002-286906

### [Patent Document 6]

Japanese Kokai Publication No. 2003-43203

### [Patent Document 7] WO 2006/059686

### DISCLOSURE OF THE INVENTION

However, in the above prior arts, attention is paid only on low reflection treatment on the surface of the display device. Influence of light reflection inside the display device has not sufficiently examined. For example, in the case of normal LC-TV, a display device consists of a pair of substrates including an array substrate and a color filter (CF), and a crystal liquid layer interposed between the pair of substrates. The array substrate may be provided with a thin film transistor (TFT) element for controlling a voltage to be applied to the liquid crystal layer, and a wiring for supplying electric signals to the TFT element. Since the TFT element and the wiring are normally formed of metals, external light comes in through the surface of the display device and travels into the display device is reflected by the TFT element and the wiring to heads for the surface of the display device.

Generally, indium tin oxide (ITO) having optical transparency is disposed in an LC-TV as an electrode to apply voltage to the liquid crystal. The refractive index of the ITO is 1.9 to 2.1, which is relatively high as compared to glass, resin, alignment layer and liquid crystal molecules, each having a refractive index of approximately 1.5. Therefore, due to the difference in the refractive index at the interface between the ITO and the other members, light may reflect on the interface depending on the incident angle. In the case that the CF substrate is disposed closer to viewer's side than the array substrate, the intensity of the reflected light is reduced by the effects of the color filter and the polarizer. However, the reflectance at the interface of the TFT element, the wiring, the ITO, and the like reaches as much as approximately 0.5 to 1.5%. The reflectance at the surface of the display device becomes as low as 0.15% when the surface of the display device employs a moth-eye structure as a treatment for providing the surface of the display device with low reflection properties. Therefore, influence of the reflection of the reflected light from inside the display device becomes dominant.

For this reason, even if a moth-eye structure is formed on the AG-treated uneven surface so as to blur an image reflected on the surface, it is not possible to blur the reflection of light source caused by reflection inside the display device. Consequently, the visibility is still low. In order to avoid the reflection of external light on the TFT element, the wiring or the like, a black matrix may be arranged on the CF substrate. However, it is practically difficult to cover all of the TFT element and the wiring with the black matrix because the black matrix is designed not for covering all of the elements and the wiring but generally for prioritizing the aperture ratio of the panel and further because the attachment accuracy of the array substrate and the CF substrate is normally ±5 μm.

The present invention has been devised in consideration of the foregoing current condition. The present invention aims to reduce reflection of light on the surface of a display device and provide a reflection-preventing film capable of reducing the influence of light reflecting inside the display device.

### MEANS FOR SOLVING THE PROBLEM

The present inventors conducted various investigations on techniques for reducing the influence of light reflecting inside the display device, and have focused their attention on a structure of a reflection-preventing film capable of reducing the reflection of light on the surface of the display device. As a result, they have found that, by providing the reflection-preventing film with certain scattering properties that can allow the light passing through and going out from the reflection-preventing film to be scattered (hereinafter, also referred to as transmission scattering properties), it is possible to scatter the light reflecting inside the display device so that influence of the reflection can be reduced. The present inventors have also found that distribution of the transmittance of the scattered light (hereinafter, also referred to as transmission scattering intensity distribution) is angle-dependent. They have further found that, when a scattering angle corresponding to half the maximum value of the transmittance (transmitting light intensity) of the scattered light (hereinafter, this angle is also referred to as half-value angle) that has twice passed through by incoming and outgoing the reflection-preventing film is 1.0° or more, reflection of image caused by the reflected light inside the display device can be blurred and thus the visibility can be improved. Accordingly, the present inventors have succeeded to solve the foregoing problems and finally completed the present invention.

Namely, the present invention is a reflection-preventing film having on its surface a fine uneven structure in which a width between adjacent top points is equal to or less than a visible wavelength, wherein a half-value angle of transmission scattering intensity distribution of light transmitted through overlapped two sheets of the reflection-preventing film is 1.0° or more.

The following description will discuss the present invention in more detail.

The reflection-preventing film according to the present invention has on its surface a fine uneven structure (hereinafter, also referred to as first uneven structure or moth-eye structure) in which a width (pitch) between adjacent top points is equal to or less than a visible wavelength. In the present invention, “equal to or less than a visible wavelength” is 400 nm or less, which is a lower limit of a general visible wavelength region, and is desirably 300 nm or less, and more desirably 200 nm or less which corresponds to a half of the lower limit of the visible wavelength region. In the case that the pitch of the moth-eye structure exceeds 200 nm, a red color wavelength at 700 nm may be occasionally colored; however, such influence is suppressed when the pitch is controlled to be 300 nm or less, and almost no influence is caused when the pitch is controlled to be 200 nm or less.

The reflection-preventing film according to the present invention is, for example, thinly formed on a plane surface of a base member. Examples of the base member on which the reflection-preventing film is to be formed include members forming an outermost surface of the display device, such as a polarizing plate, an acrylic protective plate, a hard coat layer disposed on the surface of the polarizing plate, and an antiglare layer disposed on the surface of the polarizing plate. Disposing the reflection-preventing film according to the present invention on a viewer's side of the display device as mentioned earlier makes it possible to blur the reflection of image caused by the reflected light so that the image is obscured.

According to the present invention, the half-value angle of transmission scattering intensity distribution of light transmitted through overlapped two sheets of the reflection-preventing film is 1.0° or more. The overlapped two sheets of the reflection-preventing film are described as a sample prepared by laminating the reflection-preventing film of the present invention. In practical use of the present invention, the reflection-preventing film needs not to be laminated. According to the present invention, reflection of image caused by light that is passing the reflection-preventing film after once having passed through the reflection-preventing film is suppressed. Therefore, the half-value angle of the transmission scattering intensity distribution of the reflection-preventing film is specified by using overlapped two sheets of the reflection-preventing film.

When light passes through the reflection-preventing film of the present invention, the light having passed through the reflection-preventing film scatters and exits. In the present invention, the scattering angle shows an angle of the light due to being scattered in passing through the film of the present invention. A scattering angle is calculated by subtracting “incident angle of light coming into the reflection-preventing film” from “exit angle of light exiting from the reflection-preventing film.” In the present invention, the incident angle and the exit angle refer to angles between the traveling direction of the light and the normal line direction of the plane surface of the reflection-preventing film (base member).

The transmittance of the light scattered upon passing through the reflection-preventing film differs depending on the scattering angle. In the present invention, the transmittance of the scattered light is maximum when the scattering angle is 0°, and the transmittance decreases as the scattering angle increases. Providing that the transmittance at the scattered angle of 0° is 100, when the angle (half-value angle) corresponding to half the transmittance (i.e. transmittance=50) of the scattered light is 1.0° or more, or more preferably 1.5° or more, it is possible to produce a sufficient scattering effect for reflected light generated by reflection of light inside the display device. As a result, reflection of image such as fluorescent lamp and human face can be sufficiently blurred.

The structure of the reflection-preventing film of the present invention may optionally include, as long as it includes the foregoing components as essential components, other components without any limitation. For example, although the width between adjacent top points is required to be less than a visible wavelength in the fine uneven structure disposed in the reflection-preventing film of the present invention, the height from the top point to the bottom point may be equal to, less than, or more than a visible wavelength.

The half-value angle is preferably 2.8° or less. The half-value angle of the transmission scattering intensity distribution of 1.0° or more produces sufficient scattering effects for reflection from inside the panel as described earlier. However, in the case that the half-value angle is too large, the brightness of the whole panel stands out so that viewers may feel the planarity of displayed images, occasionally resulting in loss of the stereoscopic effect of the images. On the contrary, the half-value angle of 2.8° or less can achieve display of images whose depth sense can be easily recognized by viewers.

The following description will discuss a first preferable embodiment of the reflection-preventing film according to the present invention.

Preferably, the reflection-preventing film also has on its surface a scattering uneven structure having a width between adjacent top points is 1 μm or more (hereinafter, also referred to as second uneven structure). Namely, according to this embodiment, not only a fine uneven structure (moth-eye structure) in which a width between adjacent top points is equal to or less than a visible wavelength but also a different uneven structure from the moth-eye structure, in which a width between adjacent top points is large and is equal to or more than a visible wavelength are formed on the surface of the reflection-preventing film. The two different uneven structures improve the transmission scattering properties of light passing through the reflection-preventing film, and precisely adjusts the half-value angle in the transmission scattering intensity distribution. In order to provide the reflection-preventing film with effective scattering properties, it is preferable to form an uneven surface having a cycle sufficiently covering visible wavelengths. The pitch of the uneven surface capable of achieving the effect is 1 μm or more that sufficiently covers a general maximum visible wavelength of 750 nm, or preferably 3 μm or more that is four times or more larger than a general maximum visible wavelength. In the case that the pitch is set to 1 μm, the relative length to a red light (R) wavelength is largely different from the relative length to a blue light (B) wavelength. By setting the uneven pitch to a value that is four times or more of a visible wavelength, the gap between the relative length to a red light (R) wavelength and a blue light (B) wavelength becomes smaller. As a result, display with more natural colors can be achieved, which in turn improves the quality of the display.

In the scattering uneven structure, the number of convex portions per an area of 100 μm² is preferably 60 or more. As used herein, the convex portion refers to a portion having a tapered shape extending to the outer side, among the uneven structure formed on the surface of the reflection-preventing film. In the case that the number of convex portions in the scattering uneven structure is too small relative to the pixel, variation of the brightness occurs in the respective pixel units. As a result, glare of the display may occur upon viewing in a dark room. By controlling the number of the convex portions to be 60 or more per an area of 100 μm², glare of the display can be effectively suppressed.

The following description will discuss in detail a second preferable embodiment of the reflection-preventing film according to the present invention.

The reflection-preventing film preferably has a different refractive index from that of the main component of the reflection-preventing film and also includes inside thereof scatterers each having a particle size of 1 μm or more. By allowing the reflection-preventing film to have a different refractive index from that of the main component of the reflection-preventing film and also to include structured bodies each having a micron-order (1 μm or more) particle size sufficiently covering the maximum 750 nm of visible light, it is possible to improve the transmission scattering properties of the light passing through the reflection-preventing film so that the half-value angle of the transmission scattering intensity distribution can be effectively controlled. As the main component of the reflection-preventing film according to the present invention, resins may be exemplified. In order to form a highly precise moth-eye structure, it is especially preferable to use resins which are cured under certain conditions such as thermosetting resins and photocurable resins.

The existence form of the scatterer is not particularly limited as long as the scatterer is disposed in a form capable of improving the transmission scattering properties of the light passing through the reflection-preventing film. Examples of the existence form include a form scattered inside the reflection-preventing film. According to the present embodiment, the shape of the scatterer is not particularly limited, and may be a sphere, a polygon, or an amorphous shape. As used herein, the particle size refers to a diameter of the largest part of a particle of the scatterer. The particle size can be measured with, for example, an optical microscope.

Preferably, the scatterers irregularly exist with a distance of 1 μm or more between each other. In the case that the reflection-preventing film irregularly (randomly) includes the scatterers having a different refractive index from that of the main component of the materials of the reflection-preventing film, with a distance of micron-order (1 μm or more) that sufficiently covers the maximum visible light wavelength of 750 nm between each other, the transmission scattering properties are further improved so that the half-value angle of the transmission scattering intensity distribution can be effectively controlled. As used herein, “with a distance of 1 μm or more between each other” means that the distance between centers of adjacent scatterers is 1 μm or more. For example, in the case that the scatterers have a polygonal or an amorphous shape, the distance between centers of gravity is 1 μm or more.

The reflection-preventing films according to the first preferable embodiment and the second preferable embodiment of the present invention have been explained above. The two embodiments may optionally be combined depending on the need, and such combination can further improve the transmission scattering properties so that the half-value angle of the transmission scattering intensity distribution can be more effectively controlled.

Furthermore, the present invention relates to a display device having on its surface the reflection-preventing film of the present invention. Examples of the display device include cathode ray tube (CRT) display devices, liquid crystal display (LCD) devices, plasma display panels (PDP), and electroluminescence (EL) display devices. As described earlier, generally the present invention can be preferably used especially in display devices in which components reflecting light, such as electrodes and wirings, are included. Thus, in the display device of the present invention, excellent low reflection effect can be obtained for both the reflection on the surface of the display (outer surface of the display panel) and the reflection inside the display device.

In the reflection-preventing film of the present invention, a moth-eye structure is formed on the surface, and the half-value angle of transmission scattering intensity distribution of light passing through overlapped two sheets of the reflection-preventing film is 1.0° or more. Thus, when the reflection-preventing film is arranged, for example, on the surface of the display device, light reflection on the surface of the display device can be reduced, and at the same time reflected light inside the display device can be scattered. As a result, reflection of image such as light sources on the display screen caused by the reflected light is blurred so that the quality of display can be improved.

### BEST MODE FOR CARRYING OUT THE INVENTION

The present invention is mentioned in more detail below with reference to embodiments using drawings, but not limited to only these embodiments.

### Embodiment 1

FIG. 1 is a cross-sectional view schematically showing a reflection-preventing film according to Embodiment 1. As shown in FIG. 1, the surface of the reflection-preventing film 10 according to Embodiment 1 includes a surface layer 11 having an uneven structure 13 (first uneven structure; moth-eye structure) having a cycle of less than a visible wavelength and an uneven structure 14 (second uneven structure; scattering uneven structure) having a cycle of more than a visible wavelength, and also includes a base layer 12 located below the surface layer 11. The moth-eye structure 13 is an uneven structure for reducing reflections on the surface of the reflection-preventing film 10. The scattering uneven structure 14 is an uneven structure for controlling the half-value angle of the transmission scattering intensity distribution of light that is passing through overlapped two sheets of the reflection-preventing film 10 to 1.0° or more. Namely, in Embodiment 1, the first preferable embodiment of the present invention is used as a means of controlling the half-value angle of the transmission scattering intensity distribution.

### <First Uneven Structure (Fine Uneven Structure; Moth-Eye Structure)>

FIG. 2 is a cross-sectional view showing a moth-eye structure of the reflection-preventing film according to Embodiment 1. FIG. 2(a) shows the view when the unit structure of the moth-eye structure is a cone, and FIG. 2(b) shows the view when the unit structure of the moth-eye structure is a quadrangular pyramid. As shown in FIG. 2, the moth-eye structure 13 of the reflection-preventing film according to Embodiment 1 may be described as a structure in which a plurality of fine convex portions 21 are aligned in a repeating unit at a cycle smaller than visible wavelengths. In the moth-eye structure 13, a tip of the convex portion 21 is a top point “t”, and a point at which the adjacent convex portions 21 contact each other is a bottom point “b”. As shown in FIG. 2, a width “w” between the adjacent top points of the moth-eye structure 13 is defined as a distance between two points where perpendicular lines from the respective top points “t” come in contact with a single plane surface. A height “h” from the top point to the bottom point of the moth-eye structure is defined as a distance from the top point “t” of the convex portion 21 to the plane surface having the bottom point “b” thereon.

In the reflection-preventing film according to Embodiment 1, the width “w” between adjacent top points of the moth-eye structure is 400 nm or less, preferably 300 nm or less, and more preferably 200 nm or less. In FIG. 2, a cone and a quadrangular pyramid are illustrated as a unit structure of the convex portion 21. However, according to Embodiment 1, the unit structure is not particularly limited as long as it is an uneven structure in which top points and bottom points are formed, and the width is limited to the above value range. Moreover, the unit structure may include a region where the width is partly not limited to the value range as long as the width as a whole is substantially limited in the value range.

The following description will discuss a principle of the ability of the reflection-preventing film having the moth-eye structure according to Embodiment 1 to achieve low reflection. FIG. 3 is a cross-sectional view showing the principle of how the moth-eye structure achieves low reflection. FIG. 3(a) shows a cross-sectional structure of a reflection-preventing film, and FIG. 3(b) shows the refractive index of light incident on the reflection-preventing film. As shown in FIG. 3, a moth-eye structure 13 in the reflection-preventing film according to Embodiment 1 includes a convex portion 21 and a foundation portion 22. When light passes from one medium to a different medium, the light is refracted on an interface between the mediums. The refraction angle depends on the refractive index of the medium into which the light proceeds. For example, when the medium is air or a resin, the refractive index is 1.0 or approximately 1.5, respectively. In Embodiment 1, the unit structure of the uneven structure formed on the surface of the reflection-preventing film has a drill shape, i.e., a shape in which the width gradually decreases toward the tip end. As shown in FIG. 3, in the convex portion 21 (between X and Y) located at an interface between an air layer and the reflection-preventing film, the refractive index is considered to continuously and gradually increase from about 1.0 as the refractive index of air to the refractive index of the material forming the film (about 1.5 in case of resin). The amount of light reflection is proportional to the difference between the refractive indexes of those media, and thus most light passes through the reflection-preventing film by creating a condition of substantial absence of the refractive interface as described earlier. As a result, the reflective index on the surface of the film is reduced significantly.

### <Second Uneven Structure (Scattering Uneven Structure)>

FIG. 4 is an enlarged perspective view showing a scattering uneven structure of the reflection-preventing film according to Embodiment 1. As shown in FIG. 4, the scattering uneven structure of the reflection-preventing film according to Embodiment 1 may be described as a structure in which a plurality of fine convex portions 31 are aligned in a repeating unit at a cycle larger than visible wavelengths. In the scattering uneven structure, a tip of the convex portion 31 is a top point “T”, and a point at which the adjacent convex portions 31 contact each other is a bottom point “B”. As shown in FIG. 4, a width “W” between the adjacent top points of the scattering uneven structure is defined as a distance between two points where perpendicular lines from the respective top points “T” come in contact with a single plane surface.

In the reflection-preventing film according to Embodiment 1, the width “W” between adjacent top points of the scattering uneven structure is 1 μm or more, and preferably 3 μm or more, which is much larger than the width “w” between adjacent top points of the moth-eye structure. In FIG. 4, a smooth mountain shape is illustrated as a unit structure of the convex portion. However, according to Embodiment 1, the unit structure is not particularly limited as long as it is an uneven structure in which top points and bottom points are formed, and the width is limited to the above value range. Moreover, the unit structure may include a region where the width is partly not limited to the value range as long as the width in the unit structure as a whole is substantially limited in the value range. By forming the scattering uneven structure having a cycle larger than a visible wavelength on the surface of the reflection-preventing film, the transmission scattering property of the reflection-preventing film can be improved, and the half-value angle of the transmission scattering intensity distribution can be easily and precisely controlled.

The following description will discuss a method of producing the reflection-preventing film according to Embodiment 1. In a production method below, a mold for forming an uneven pattern on the reflection-preventing film according to Embodiment 1 is first produced. The mold is pressed to the surface of a resin coat applied to the surface of the base member so as to transfer (imprint) the uneven pattern of the mold on the coat surface. Simultaneously, the resin coat is cured under a certain condition to cure the uneven pattern imprinted to the surface of the reflection-preventing film so that a predetermined uneven pattern is molded.

### <Production of Mold>

For forming, on the surface of a mold, an uneven pattern for forming a scattering uneven structure of the reflection-preventing film, first, an aluminum (Al) substrate as a material of the mold is subjected to sandblasting on its surface to form an Uneven pattern larger than a visible light wavelength order. Specifically, numerous abrasive grains are sprayed with pressurized air to the surface of the aluminum substrate so that foreign substances or organic matters are removed with the abrasive grains from the surface, and also numerous uneven patterns are formed on the surface of the aluminum substrate. Examples of the abrasive grains include alumina, carborundum, alundum, diamond, emery, garnet, boron carbide, colcothar, chrome oxide, glass powder, calcined dolomite, and silicic acid anhydride. For example, the abrasive grains having a particle size of 50 to 2000 mesh are sprayed at an air pressure of 2 to 15 kg/cm² to form an uneven pattern. The size of the scattering uneven structure of the reflection-preventing film according to Embodiment 1 can be adjusted by controlling the size of the grains to be used in sandblasting, the hardness of the grains, and time period of sandblasting, and thereby the half-value angle can be controlled.

Next, the uneven pattern for forming the moth-eye structure of the reflection-preventing film is formed on the surface of a mold. In this example, an alumina (Al₂O₃) film with a plurality of fine pores (micropores) having a size of a visible light wavelength or less formed by anodization of aluminum (hereinafter, also referred to as anodized porous alumina) is produced on a large area of the surface of the mold. The final shape of the uneven pattern formed on the anodized porous alumina is a triangle in the cross section, and the shape is formed by repeating step by step the pore formation by anodization of aluminum and etching of the anodic-oxide film.

The following description will discuss the structure of the anodized porous alumina. FIG. 5 is an enlarged perspective view of the anodized porous alumina. As described earlier, the anodized porous alumina refers to an porous alumina layer obtained by anodization of an aluminum substrate 44, and may be schematically illustrated by a structure with closest packed columnar alumina layers each having a uniform columnar shape called a cell 41. A micropore 42 is formed in the center of each of the cells 41 and the micropores 42 are regularly aligned. The cells 41 are formed as a result of local dissolution and growth of a coating. Specifically, the cells 41 are formed when dissolution and growth of the coating simultaneously proceed in a barrier layer 43 located at the bottom of the micropores 42. The distance (cell size) between the micropores 42 is proportional to the strength of anodization voltage during the anodization, and may be approximately twice the thickness of the barrier layer 43. The diameter of the micropore 42 depends on the kind, concentration, temperature, and the like of the anodization bath, and may be approximately one third the size of the cell.

In the present embodiment, attention has been paid to the phenomenon that the micropores of the anodized porous alumina are formed perpendicularly to the substrate surface. Moreover, when anodization is once stopped and then resumed under the same condition, the same micropores are formed downward from the bottom of the previously micropores as starting points. By making use of this characteristic, the micropores are controlled to have a triangle cross-section. According to the method of producing a porous structure utilizing anodization, it is possible to form nanometer scale columnar micropores in almost closest packed state. By immersing a material to be processed in either an acid electrolytic solution such as sulfuric acid, oxalic acid, and phosphoric acid, or an alkali electrolytic solution, and then applying a voltage using the material to be processed as anode, oxidation and dissolution simultaneously proceed on the surface of the material to be processed. Thereby, it is possible to form an oxide film having fine columnar pores on the surface. The columnar micropores are aligned vertically to the oxide film, and exhibit self-organized regularity under certain conditions including anodization voltage, kinds of the electrolytic solution, and temperatures. By controlling the conditions and time period, the size, shape, or density can be freely controlled.

FIG. 6 is a cross-sectional view schematically showing a production flow of anodized porous alumina. In FIG. 6, (a) to (g) show respective production steps. First, as shown in (a), an aluminum substrate 51 is prepared and an oxide film is grown under certain anodization conditions so as to form a porous alumina layer (first porous alumina layer) 52 having aligned micropores with a certain depth as shown in (b). In this process, the anodization voltage is preferably kept constant. Since variation of the anodization voltage reduces regularity of the alignment of the micropores, the anodization is basically performed under a constant voltage. An anodized film generated at an early stage (first porous alumina layer) 52 tends to have irregular micropores, and thus the anodized film 52 is preferably removed by phosphate acid treatment under certain conditions as shown in (c). Thereafter, anodization is again performed under the same condition so that a porous alumina layer (second porous alumina layer) 53 having regularly aligned micropores with a certain depth as shown in (d) is formed. Next, as shown in (e), the micropores are isotropically etched for a certain amount so as to increase the pore diameter. In the case that a wet process is employed for the above step, walls and barrier layers of the micropore are almost equally enlarged. As shown in (f) and (g), a desired uneven pattern can be formed by repeating the formation of micropores in a direction for inside the substrate from, as a starting point, the bottoms of the micropores that have been previously formed by anodization, and the isotropic etching treatment.

FIG. 7 shows a cross-sectional view schematically showing shapes of micropores to be formed when the above steps are repeated several times with the amount of pore formation (depth direction) and the amount of etching (width direction) kept constant. FIG. 7(a) is a view showing the shape of the micropore transcribed in a graph, and FIG. 7(b) is a perspective cross-sectional view of the micropores. As shown in FIG. 7, according to the above method, each of the micropores 63 on the porous alumina layer 62 obtained by anodization of the aluminum substrate 61 have almost cone shapes. The shape can be more strictly made conical when the number of steps is increased. Practically, by repeating the steps for a finite number of times, a step structure is formed on the surface of the micropores as one of the features of the uneven structures.

The above description has discussed the method of producing the molds for forming the moth-eye structure (first uneven structure) and the scattering uneven structure (second uneven structure) on the reflection-preventing film; however, the production method of the mold is not limited thereto. Examples of the method to obtain the scattering uneven structure, other than the aforementioned sandblast surface treatment, include chemical etching. Examples of the method to obtain the moth-eye structure, other than the aforementioned anodization and the etching, include electron beam lithography and laser interference exposure.

In the case of forming two-stage uneven patterns having different cycles (repeating units) on the surface of the mold, the surface is preferably subjected to sandblasting prior to the anodization treatment. Formation of an uneven structure with a larger cycle before an uneven structure with a smaller cycle makes it possible to precisely form both of the moth-eye structure and the scattering uneven structure on the surface, which in turn provides a high quality reflection-preventing film. Moreover, as sandblasting forms an uneven pattern with random and large pitch, it is possible to prevent coloring caused by interference with surface reflected light as well as to blur images.

### <Imprint Process>

Next, the uneven pattern of the mold prepared in the above step is imprinted on a coat applied to the substrate. For the imprinting, a roll-to-roll system is employed in which a rotating roll-shaped mold is pressed onto a coat transferred by a conveyer system so that the uneven pattern is sequentially imprinted onto the surface of the coat. FIG. 8 is a cross-sectional view schematically showing steps for imprinting the uneven surface shape of a mold on a layer.

First, a belt base member film 81 is sent forth from a rotating base member film roll 71 to the direction of an arrow shown in FIG. 8. Next, a resin material is applied over the base member film 81 with a die coater 72 to form a resin coat 82. Other application methods include a method using a slit coater, a gravure coater and the like.

In the present production method, examples of the resin material to be applied include curable resins such as photocurable resins and thermosetting resins. Examples of the photocurable resins include a monomer which polymerizes upon light absorption and a monomer which does not polymerize by itself upon light absorption but polymerizes when a photopolymerization initiator is blended as active species upon light absorption to cause polymerization. A photopolymerization initiator, a photosensitizer and the like may be optionally added.

The base member film 81 coated with the resin coat 82 proceeds to a cylindrical mold roll 74 via a pinch roll 73. The external surface of the mold roll 74 is provided with the anodized porous alumina formed in the aforementioned production of mold. The base member film 81 moves along the outer surface of the mold roll 74 for half of the round. In this moving, the resin coat 82 applied to the base member film 81 contacts the outer surface of the mold roll 74 so that the uneven pattern of the mold roll 74 is imprinted to the resin coat 82. At a contact position of the base member film 81 and the mold roll 74, a cylindrical pinch roll 75 is disposed facing the outer surface of the mold roll 75. At this position, the base member film 81 is sandwiched by the mold roll 74 and the pinch roll 75 so that the mold roll 75 and the resin coat 82 are pressurized and adhered to one another. As a result, a resin coat 83 having the same uneven pattern as that of the mold is formed on the surface of the resin coat 82.

In order to sandwich the base member film 81 by the mold roll 74 and the pinch roll 75, the width of the base member film 81 is preferably smaller than that of the mold roll 74 and the pinch roll 75. The pinch roll 75 is preferably made of rubber. After imprinting the uneven pattern on the surface of the resin coat 83, the base member film 81 moves along the outer surface of the mold roll 74 to a pinch roll 76 and then shifts for the next process via the pinch roll 76.

In the contacting of the base member film 81 with the outer surface of the mold roll 74, the resin coat 83 on the base member film 81 is subjected to curing treatment 80. In the case that the base member film 81 is photocurable, the light irradiation is performed with light in the appropriate wavelength region (e.g. ultraviolet light, visible light) for the resin material and at an intensity and for a time period suitable for curing the resin material. In the case of curing by light irradiation, the curing treatment can be performed at room temperatures. In the case that the base member film 81 has thermosetting properties, heating is performed at a temperature and for a time period suitable for curing the resin material. Those curing treatments harden the uneven pattern imprinted on the resin coat 83.

Thereafter, a lamination film 84 supplied from a lamination film roll 77 is attached with a pinch roll 78 on the surface of the resin coat 83. Lastly, a multilayer film consisting of the base member film 81, the resin coat 83, and the lamination film 84 is rolled up so that a multilayer film roll 85 is prepared. Attachment of the lamination film 84 makes it possible to prevent dust or scratches on the surface of the resin coat 83.

By carrying out the above process, a reflection-preventing film according to Embodiment 1 is produced.

### <Evaluation Test 1>

In order to examine the properties of the reflection-preventing film of Embodiment 1, a reflection-preventing film was actually produced as the reflection-preventing film of Example 1 and an evaluation test was performed. The following description discusses a production method of the reflection-preventing film of Example 1. First, for producing the mold, an aluminum substrate was subjected to sandblasting with Al₂O₃ particles having a size of 180 mesh under air pressure of 0.8 MPa, followed by anodization using 0.05 mol/L oxalic acid (3° C.) as an electrolytic solution for 5 minutes, so that an anodized porous alumina layer (first porous alumina layer) was formed on the surface of the aluminum substrate. Thereafter, the aluminum substrate having on its surface the anodized porous alumina layer was immersed for 30 minutes in 8 mol/L of phosphoric acid (30° C.) to remove the first porous alumina layer. Next, step of anodization under the same condition for 30 seconds and step of etching by immersion in 1 mol/L phosphoric acid (30° C.) for 19 minutes were alternately repeated 5 times each, followed lastly by anodization under the same condition for 30 seconds, and thereby a new anodized porous alumina layer (second porous alumina layer) was formed.

FIG. 9 shows electron micrographs of the uneven structure (for forming moth-eye structure) of the surface of the mold used to produce the reflection-preventing film in Example 1. FIG. 9(a) is a front view of the uneven structure, FIG. 9(b) is a perspective view of the uneven structure, and FIG. 9(c) is a cross-sectional view of the uneven structure. In the uneven structure provided on the mold, the width between adjacent top points was about 200 nm, and the height (depth) from the top point to the bottom point was about 840 nm (aspect ratio: about 4.2). Concave portions 92 and convex portions 91 in the uneven structure of the mold were formed by disposing the pointed convex portions 91 at regular intervals in the closest packed state. The surface of the convex portion 91 has a stepwise shape generated due to the several times repetition of anodization and etching.

Then, according to the roll-to-roll imprint of Embodiment 1 using thus-prepared mold, the uneven pattern of the mold was imprinted to a UV (ultra violet) curable resin coat applied on a PET (Poly Ethylene Terephthalate) film as base member film by pressing the uneven pattern of the mold to the UV curable resin coat, and then the UV curable resin coat was irradiated with ultraviolet light so that the UV curable resin coat was cured while maintaining the uneven pattern. Accordingly, the reflection-preventing film of Example 1 was formed.

Next, as a comparison to Example 1, a reflection-preventing film of normal multilayer thin film reflection (LR) type having no moth-eye structure on the surface was prepared as Comparative Example 1. The surface reflectance of each of the reflection-preventing film of Example 1 and the reflection-preventing film of Comparative Example 1 was measured. FIG. 10 is a graph showing the reflectance of the surface of the reflection-preventing film in Example 1 and the reflectance of the surface of the reflection-preventing film in Comparative Example 1. The graph in FIG. 10 shows the spectrum reflectance of regular reflected light, with the horizontal axis indicating wavelength (nm) and the vertical axis indicating reflectance (%). As shown in FIG. 10, in the case of the reflection-preventing film of Example 1, the reflectance in visible region was suppressed to approximately 0.2% and reflection diffraction light was not generated. On the contrary, in the case of the reflection-preventing film of Comparative Example 1, the reflectance invisible region was as high as 0.7% or more, meaning that the reflection-preventing film did not have sufficient low reflection effect. Accordingly, the reflectance on the surface of the reflection-preventing film of Example 1 was confirmed to be sufficiently reduced as compared with that of the reflection-preventing film of conventional multilayer thin film reflection type (Comparative Example 1).

Then, as a comparison to Example 1, a reflection-preventing film on the surface of which the moth-eye structure was formed but the scattering uneven structure was not formed, namely, a normal reflection-preventing film having the moth-eye structure on the surface was prepared as reflection-preventing film of Comparative Example 2. The reflection-preventing film of Comparative Example 2 was produced in the same manner as in the production method of the reflection-preventing film according to Embodiment 1, except that sandblasting was not performed. Each of the reflection-preventing film of Example 1 and the reflection-preventing film of Comparative example 2 was used in a liquid crystal display device shown in Embodiment 3 below, and the degree of reflection of fluorescent lamp was observed with eyes in a bright room. FIG. 11 is a photograph showing the level of reflection of a fluorescent lamp when the reflection-preventing films in Example 1 and Comparative Example 2 were used. The result shows that the outline of the fluorescent lamp was blurred in the liquid crystal display device provided with the reflection-preventing film of Example 1, while the outline of the fluorescent lamp was sharp in the liquid crystal display device provided with the reflection-preventing film of Comparative Example 2.

In order to further study the characteristic difference between those reflection-preventing films, a test was performed for studying the transmission scattering properties of light passing through overlapped two sheets of the reflection-preventing film of Example 1. FIG. 12 is a schematic view showing scattering of light that penetrates overlapped two sheets of the reflection-preventing film. FIG. 13 is a schematic view showing scattering of light after having been reflected by a reflector located below the reflection-preventing film.

For investigating the reflection scattering properties of the reflection-preventing film in a practical use in the display device, it is necessary to examine not only the scattering properties on the surface of the reflection-preventing film (display device) but also light scattering properties of light, that had been reflected inside the display device, in passing through the reflection-preventing film. For this reason, in the present example, the light scattering properties of light that had passed through overlapped two sheets of a reflection-preventing film 111 was measured as shown in FIG. 12. The scattering angle θ of the scattering light may be considered the same with the scattering angle θ of light shown in FIG. 13, that scatters in passing through a reflection-preventing film 121 having moth-eye structure, after once passing through the reflection-preventing film 121 and then reflecting on a reflector 122, made of glass or the like, attached to the reflection-preventing film 121. According to the above, in the case, for example, that a reflection-preventing film is formed on the surface of a display panel, it is possible to examine the scattering properties of the light that passes through the reflection-preventing film formed on the surface of the display panel after having reflected inside the display device.

As an evaluation sample, overlapped two sheets of the anti-reflected film were prepared as sample 1. FIG. 14 is a cross-sectional view showing the sample 1 formed by overlapping two sheets of reflection-preventing films. As shown in FIG. 14, the sample 1 was produced by overlapping a reflection-preventing film 131 of Example 1, a TAC (Tri Acetyl Cellulose) film 132, a glass 133, the TAC film 132 and the reflection-preventing film 131 of Example 1 in this order and binding them with a glue film interposed therebetween. The reflectance of each of the reflection-preventing film, the TAC film, the glass and the glue film was approximately 1.5.

Further, sample 2 was produced as an evaluation sample by overlapping two sheets of the reflection-preventing film of Comparative Example 2 having moth-eye structure with no scattering uneven structure (sandblasting was not performed) in the same layer structure as that of the sample 1.

The transmission scattering properties of the above evaluation samples were examined using a spectrocolorimeter LCD-5000 manufactured by Otsuka Electronics Co., Ltd, and the results shown in FIG. 15 were obtained. FIG. 15 is a graph showing the angle dependence of the transmitting light intensity in the cases of using overlapped two sheets of the reflection-preventing film in Example 1 and overlapped two sheets of the reflection-preventing film in Comparative Example 2. The graph in FIG. 15 shows the scattering angle of light that has passed through the evaluation samples and the transmittance of the light that scattered at the angle, with the horizontal axis indicating scattering angle (deg) and the vertical axis indicating transmittance (%). In the graph in FIG. 15, the light intensity (front intensity) at the scattering angle of 0° is set corresponding to the transmittance of 100%. The transmittance (transmitting intensity) of light at other scattering angles is expressed as a relative value of the front intensity.

As shown in the graph in FIG. 15, the curve of sample 1 is moderate compared with that of sample 2, with the angle (half-value angle) corresponding to half the maximum transmittance (scattering angle=0°) of sample 1 being approximately 1.3°. The half-value angle of the sample 2 was 0.6°. Accordingly, it is shown that, when the half-value angle of the transmission scattering intensity distribution of light passing through the overlapped two sheets of the reflection-preventing film is 1.0° or more, sufficient transmission scattering properties can be provided, and also reflection of image such as light sources can be reduced.

Lastly, the reflection-preventing film of Example 1 was attached to the panel surface of a liquid crystal display device described in Embodiment 3 below to complete the liquid crystal display device. The reflection scattering properties including both of the reflection on the surface of the reflection-preventing film and the reflection inside the panel of the liquid crystal display device were measured. FIG. 16 is a graph showing the angle dependence of the reflected light intensity in a liquid crystal display device equipped with the reflection-preventing film of Example 1. The graph in FIG. 16 shows the scattering angle of light that has reflected in the liquid crystal display device of Example 1 and the reflection of the light that scattered at the angle, with the horizontal axis indicating scattering angle (deg) and the vertical axis indicating reflectance. In the graph in FIG. 16, the light intensity (front intensity) at the scattering angle of 0° is set corresponding to the reflection of 1. The reflectance (reflection intensity) of light at other scattering angles is expressed as a relative value of the front intensity.

As shown in the graph in FIG. 16, the half-value angle of the reflection scattering light including both of the inside reflection and the surface reflection of the panel of the liquid crystal display device equipped with the reflection-preventing film of Example 1 is approximately 1.2°, which is a value sufficient for blurring reflection of image on a display screen.

### <Evaluation Test 2>

In order to investigate preferable conditions for the reflection-preventing film according to Embodiment 1, three kinds of reflection-preventing films with different half-value angles, each being 1.0° or more, of the transmission scattering intensity distribution of light having passed through the overlapped two sheets of the reflection-preventing film were prepared. The reflection-preventing films were prepared using molds sandblasted under different conditions including sandblasting with Al₂O₃ particles having a size of 180 mesh at air pressure of 0.1 MPa (Sample 3), 0.2 MPa (Sample 4), and 0.3 MPa (Sample 5), as reflection-preventing films of Example 3, Example 4, and Example 5, respectively. Further, in order to obtain the half-value angle of the transmission scattering intensity distribution of each of the reflection-preventing films of Example 2, Example 3, and Example 4, evaluation samples were prepared as sample 3, sample 4, and sample 5 by laminating the reflection-preventing film, a TAC film, a glass, a TAC film and the reflection-preventing film in this order, as in the same manner as in the evaluation test 1. The half-value angle of the transmission scattering intensity distribution of each of the samples was measured. As a result, a graph shown in FIG. 17 was obtained.

FIG. 17 is a graph showing the angle dependence of the transmitting light intensity of light that passes through each of the sample 3, the sample 4, and the sample 5 produced in Evaluation Test 2. The graph in FIG. 23 shows the scattering angle of light that has passed through the evaluation sample and the transmittance of the light that scattered at the angle, with the horizontal axis indicating scattering angle (deg) and the vertical axis indicating transmittance (%). In the graph in FIG. 17, the light intensity (front intensity) at the scattering angle of 0° is set corresponding to the transmittance of 100%. The transmittance (transmitting intensity) of light at other scattering angles is expressed as a relative value of the front intensity. As shown in the graph in FIG. 17, the half-value angle of the sample 3 was about 1.3°, the half-value angle of the sample 4 was about 2.0°, and the half-value angle of the sample 5 was about 2.9°.

FIG. 18 is a graph showing measured values of the tilt angle distribution (occupancy in tilt angle θ) of the sample 3, sample 4, and sample 5 prepared in the evaluation test 2. Each angle (θ) on the horizontal axis refers to a polar angle of the normal vector on the measurement surface, with 0.5° representing an angle included in the range of 0° to 1°. As shown in FIG. 18, in the case of the sample 3, the larger the tilt angle was, the smaller was the ratio of the area occupying in the measurement surface. In both of the cases of the sample 4 and the sample 5, the ratio of the area of 1.5° was larger than that of 0.5° in the measured surface; however, the larger the tilt angle was, the smaller was the ratio of the area of an tilt angle of larger than 1.5° in the measurement surface. Regarding the amount of reduction in the ratio of the area occupying in the measurement surface, the sample 3 showed a sharper reduction than the sample 4 and the sample 5, with the area in the region of the tilt angle of 3.5° or more almost absent in the case of the sample 3. Although, a sharper reduction was observed in the case of the sample 4 than the sample 5, tendency of the change as a whole is similar each other. In both of the cases of the sample 4 and the sample 5, the region of the tilt angle of 9.5° or more was not observed.

The result of a visual evaluation test indicates that favorable display was achieved in the cases in which the reflection-preventing films of Example 2 (half-value angle=1.3°) and Example 3 (half-value angle=2.0°) were used. In the case of using the reflection-preventing film of Example 4 (half-value angle=2.9°), stereoscopic effect of the displayed image was not obtained unlike the cases of using the reflection-preventing films of Example 2 and Example 3. The results indicate that increase in the half-value angle correlates with the improvement in the stereoscopic effect of the displayed images, and that the stereoscopic effect of the displayed image is obtainable by setting the half-value angle to 2.8° or less and that the stereoscopic effect is more effectively obtainable by setting the half-value angle to 2.0° or less.

In order to more precisely investigate differences relating to the half-value angles, in evaluation test 2, the uneven structures of the reflection-preventing films of Example 2, Example 3, and Example 4 were analyzed in detail. More specifically, a mean tilt angle of the scattering uneven structure of the reflection-preventing film was measured using a differential interference microscope, the scattering uneven structure being basically formed by subjecting the mold to sandblasting. The surface of each of the samples was observed through a filter with a nanometer grid. The depth of the uneven pattern at arbitrary three points on intersections of the grid were calculated to thereby obtain a mean value. According to the measurement, the mean tilt angle of the sample 3 was 0.84° and the mean tilt angle of the sample 4 was 1.75°. The results indicate that the amount of change in the half-value correlates with the amount of change in the mean tilt angle, and a sufficient half-value angle can be obtained by setting the mean tilt angle of the scattering uneven structure to at least 0.84° or more.

### <Evaluation Test 3>

In order to investigate preferable conditions for the reflection-preventing film according to Embodiment 1, the reflection-preventing film of Example 1 and the reflection-preventing film of Comparative Example 2 were actually applied to a liquid crystal display device according to Embodiment 3 mentioned below. Display quality at dark places of each of the reflection-preventing films was examined by a visual evaluation test based on visual observation. The liquid crystal display device used herein had a pixel size of 20 inch WXGA (100 μm×30 μm) with a single green color filter (G).

The results indicate that the liquid crystal display device provided with the reflection-preventing film of Example 1 exerted excellent display, while the liquid crystal display device provided with the reflection-preventing film of Comparative Example 2 had glare on the display. The brightness of each of the liquid crystal display devices per pixel was measured so that standard deviation of the variation in the brightness was calculated. FIG. 19 is a graph showing the variation in the brightness depending on the number of pixels. FIG. 19(a) is a liquid crystal display device to which the reflection-preventing film of Example 1 is applied. FIG. 19(b) is a liquid crystal display device to which the reflection-preventing film of Comparative Example 2 is applied. As indicated in FIG. 19, application of the reflection-preventing film of Example 1 resulted in the standard deviation of 0.017, and application of the reflection-preventing film of Comparative Example 2 resulted in the standard deviation of 0.029. Accordingly, glare of the display was visually recognized based on variation in the brightness in the respective pixels. As the variation in the brightness changed depending on the viewing direction, glare was visually recognized.

Next, investigation was made on conditions which cause the variation in the brightness. FIG. 20 is a schematic plane view showing the unevenness formed on the surface of the reflection-preventing film. As shown in FIG. 20, a plurality of convex portions 142 causing scattering of light are formed per unit area 141 on the surface of the reflection-preventing film. In the present evaluation test, an existence ratio of the convex portions 142 per unit area 141 in the scattering uneven structure was measured. As the evaluation samples, a reflection-preventing film of Example 5 and a reflection-preventing film of Example 6, which were subjected to sandblasting treatment under different conditions were produced as well as the reflection-preventing films of Example 1 and Comparative Example 1. For the reflection-preventing film of Example 5, conditions for sandblasting included Al₂O₃ particles with a size of 180 mesh and air pressure of 0.8 MPa. For the reflection-preventing film of Example 6, conditions for sandblasting included Al₂O₃ particles with a size of 60 mesh and air pressure of 0.2 MPa.

FIG. 21 is a graph showing relationships between the number of convex portions per unit area and variation in the brightness (standard deviation). In the graph in FIG. 21, the horizontal axis indicates AG density (pcs/100 μm²) and the vertical axis indicates variation in brightness (standard deviation). As shown in FIG. 21, the number of convex portions existing per 100 μm² of the reflection-preventing film of Example 1 with the standard deviation of the brightness of 0.017 was about 65, while the number of convex portions existing per 100 μm² of the reflection-preventing film of Comparative Example 1 with the standard deviation of the brightness of 0.029 was about 5.

Scattering per unit of the convex structure was investigated on the newly produced reflection-preventing film of Example 5 with the standard deviation of the brightness of 0.012 and the reflection-preventing film of Example 6 with the standard deviation of the brightness of 0.036. The results indicate that the number of the convex portions existing per 100 μm² was about 130 in Example 5, which achieved excellent display with no glare. Meanwhile, the number of the convex portions existing per 100 μm² was about 5 in Example 6, in which glare was frequently recognized.

Those results indicate that the larger the scattering unit of the uneven structure relative to the pixel was, namely, the smaller the number of the uneven structure relative to the pixel unit was, the more the variation in the brightness in the respective pixel units occurred. On the contrary, the larger the number of the uneven structure relative to the pixel unit was, the more the variation in the brightness in the respective pixel units was suppressed. Specifically, in the case that the number of the uneven structure relative to the pixel unit was 60 pcs/100 μm² or more, excellent display with glare sufficiently suppressed was achieved.

### Embodiment 2

In Embodiment 1, transmitting light is scattered by the moth-eye structure formed on the surface having a scattering uneven structure of micron-order size or more. In Embodiment 2, a moth-eye structure is formed on a virtually plane surface, and, in place of the scattering uneven structure of a micron-order size or larger, transparent beads (scatterers) with light scattering properties are mixed in a layer lower than the surface layer having the moth-eye structure, and thereby transmitting light is scattered. In other words, in Embodiment 2, a second preferable embodiment of the present invention is employed as a means to adjust the half-value angle in the transmission scattering intensity distribution.

FIG. 22 is a cross-sectional view schematically showing the reflection-preventing film according to Embodiment 2. As shown in FIG. 22, the reflection-preventing film according to Embodiment 2 has a surface layer 151 on which uneven structure with a small cycle (moth-eye structure) is formed and a foundation layer 152 containing transparent beads 153 having a different refractive index from that of the main component of the reflection-preventing film.

The moth-eye structure provided on the reflection-preventing film according to Embodiment 2 is the same with the moth-eye structure provided on the reflection-preventing film according to Embodiment 1, and the width between adjacent top points is designed to be a visible wavelength of less.

The main components used in the reflection-preventing film according to Embodiment 2 are resins such as a photocurable resin or a thermosetting resin from the view from the viewpoint of precisely forming the moth-eye structure. Inside the foundation layer 152 of the reflection-preventing film according to Embodiment 2, the transparent beads 153 are partially dispersed that are formed of materials having a different refractive index from that of resin materials as the main component of the reflection-preventing film according to Embodiment 2.

The transparent beads 153 are not particularly limited as long as they have a different refractive index from that of the main component of the reflection-preventing film and also can improve the transmission scattering properties. Examples of the components of the transparent beads 153 include styrene resins, fluororesins, and polyethylene resins. In the case of styrene resins, the refractive index is about 1.6, which has a gap of about 0.1 with the refractive index of about 1.5 of preferable UV curable resins as a main component of the reflection-preventing film. Therefore, it is possible to obtain a reflection-preventing film with excellent transmission scattering properties. The reflective index of fluororesins is 1.42, and the reflective index of polyethylene resins is 1.53.

Although each of the transparent beads 153 has a spherical form in FIG. 22, the shape is not particularly limited. The transparent beads 153 having other shapes such as a polygon and an amorphous shape may be used as well. The transparent beads 153 have a particle size of not less than 1 μm. The particle size of micron order makes it possible to obtain effective transmission scattering properties.

The transparent beads 153 are not limited to those consisting only of the resin component, and may be, for example, hollow beads filled with gas such as air. Moreover, the scatterers 153 may be bubbles consisting only of gas such as air.

In Embodiment 2, each of the transparent beads 153 is set to have a particle size of 1 μm or more. Practically, however, the transparent beads 153 may exist in a gathered and clumped form, and in this embodiment, it is still possible to provide the light passing through the reflection-preventing film with transmission scattering properties. However, by for example reducing the density and sufficiently homogenizing the transparent beads 153 so as to allow them to be arranged with a distance of 1 μm or more between each other, the transparent beads 153 may be disposed in a well-balanced manner. Accordingly, the transparent beads 153 having better transmission scattering properties can be obtained.

The following description will discuss a method of producing the reflection-preventing film according to Embodiment 2.

First, a mold for forming a moth-eye structure on the surface of a reflection-preventing film is prepared. The mold to be prepared in this process is almost the same as the anodized porous alumina prepared in Embodiment 1, except that, since the mold in Embodiment 2 is prepared without sandblasting, the surface shape thereof does not include the scattering uneven structure according to Embodiment 1, and therefore, the surface is virtually plane with exception of the moth-eye uneven structure.

Next, transparent beads are mixed into a resin material as a material for a reflection-preventing film. The resin material containing the transparent beads is applied to the base member film in the same manner as in Embodiment 1. After imprinting the uneven pattern using the anodized porous alumina, curing treatment is performed under predetermined conditions so that the reflection-preventing film according to Embodiment 2 is completed.

### <Evaluation Test 4>

In order to investigate properties of the reflection-preventing film according to Embodiment 2, a reflection-preventing film was actually produced as a reflection-preventing film of Example 5, and evaluation test 4 was performed on the reflection-preventing film. The mold used was prepared by forming an aluminum thin film having a thickness of about 1 μm on a glass substrate, not on an aluminum substrate for keeping the surface smooth. Using the mold, an anodized porous alumina (alumina having nanometer-order micropores on its surface) was formed by repeating anodizing and etching in the same manner as in Embodiment 1.

Meanwhile, 3% by weight of transparent beads (average particle diameter φ=8.0 μm) made of styrene resin were mixed into a UV curable resin to prepare a material for a reflection-preventing film, and the material was applied to a base member film. The refractive index of the UV curable resin of Example 5 was 1.49, and the refractive index of the transparent beads was 1.59. The thickness of the UV curable resin on the base member film was set to 100 μm. Next, the uneven pattern was imprinted to the surface of the UV curable resin using the mold, and the uneven surface was cured by UV irradiation so that the reflection-preventing film of Example 7 was formed.

Next, two sheets of the reflection-preventing film were overlapped to prepare a sample 6 as an evaluation sample. The half-value angle of the transmission scattering intensity distribution of the sample 6 was measured in the same manner as in the evaluation test 1. Examination of the transmission scattering properties using the evaluation sample gave the results shown in FIG. 23. FIG. 23 is a graph showing the angle dependence of the transmitting light intensity on overlapped two sheets of the reflection-preventing film of Example 7. The graph in FIG. 23 shows the scattering angle of light that has passed through the evaluation sample and the transmittance of the light that scattered at the angle, with the horizontal axis indicating scattering angle (deg) and the vertical axis indicating transmittance (%). In the graph in FIG. 23, the light intensity (front intensity) at the scattering angle of 0° is set corresponding to the transmittance of 100%. The transmittance (transmitting intensity) of light at other scattering angles is expressed as a relative value of the front intensity.

As shown by the graph in FIG. 23, the half-value angle of the sample 6 was about 2.0°. As demonstrated by the result, overlapped two sheets of the reflection-preventing film of Example 7 can provide sufficient transmission scattering properties, which in turn can reduce reflection of image such as light sources.

Lastly, the reflection-preventing film of Example 7 was attached to the panel surface of a liquid crystal display device described in Embodiment 3 below to produce the liquid crystal display device. The reflection scattering properties including both of the reflection on the surface of the reflection-preventing film and the reflection inside the panel of the liquid crystal display device were measured. FIG. 24 is a graph showing the angle dependence of the reflected light intensity in a liquid crystal display device equipped with the reflection-preventing film of Example 7. The graph in FIG. 24 shows the scattering angle of light that has reflected in the liquid crystal display device of Example 7 and the reflection of the light that scattered at the angle, with the horizontal axis indicating scattering angle (deg) and the vertical axis indicating reflectance. In the graph in FIG. 24, the light intensity (front intensity) at the scattering angle of 0° is set corresponding to the reflection of 1. The reflectance (reflection intensity) of light at other scattering angles is expressed as a relative value of the front intensity.

As shown in the graph in FIG. 24, the half-value angle of the reflection scattering light including both of the inside reflection and the surface reflection of the panel of the liquid crystal display device equipped with the reflection-preventing film of Example 5 is approximately 2.0°, which is a value sufficient for blurring reflection of image on a display screen.

### Embodiment 3

Embodiment 3 is one example of the display device of the present invention. The display device according to Embodiment 3 is a liquid crystal display device (LCD) which is equipped with the display surface of the reflection-preventing film according to Embodiment 1 or 2. Therefore, the display device of the Embodiment 3 can provide display with little reflection of image such as light sources.

FIG. 25 is a schematic cross-sectional view of the LCD according to Embodiment 3, showing reflection of external light in the LCD. As shown in FIG. 25, the panel portion of the LCD according to Embodiment 3 includes a pair of substrates 161 and 162, and a liquid crystal layer 163 interposed between the pair of substrates 161 and 162. The pair of substrates 161 and 162 may take a configuration consisting of an array substrate 161 on one side and a color filter substrate 162 on the other side, and an electrode is disposed at each of both the substrates. The liquid crystal layer 163 can be driven and controlled by the influence of the electric field generated between those electrodes. In Embodiment 3, other configurations may be employed without any limitation, such as a configuration in which one of the substrates functions as both an array substrate and a color filter substrate, or a configuration in which electrodes are disposed only on one of the substrates. Moreover, the method of controlling alignment of liquid crystal molecules in the liquid crystal layer 163 is not particularly limited, and may be a TN (Twisted Nematic) mode, a VA (Vertical Alignment) mode, and an IPS (In-Plane Switching) mode. A light control element such as a polarizer is disposed on the opposite side of the liquid crystal layer 163 side in the array substrate 161 or the color filter substrate 162.

The array substrate 161 includes a support substrate 171 made of glass, plastic or the like, on which are mounted a wiring for controlling the alignment of liquid crystals in the liquid crystal layer 163, an electrode or the like. The method of driving liquid crystal may be passive matrix type or active matrix type. In the matrix type driving method, wirings are arranged to intersect each other. A plurality of regions surrounded by the wirings form a matrix configuration. The wirings and the electrodes preferably include a material such as aluminum (Al), silver (Ag), tantalum nitride (TaN), titanium nitride (TiN), and molybdenum nitride (MoN) for excellent functionality and productivity, and the materials normally have reflecting properties.

In the case of the active matrix type, a semiconductor switching element such as a thin film transistor (TFT) 174 which controls signals transmitted from each of the wirings is disposed at each intersection of the wirings. The TFT 174 has an electrode 172 for applying a bias voltage to a semiconductor layer 173. The aforementioned materials for the wirings and the electrodes are also preferably used as the materials for the electrode, and thus the electrode has reflecting properties.

An insulation interlayer 175 is formed on the wirings and the TFT 174. Further, on the insulation interlayer 175, a pixel electrode 176 formed of a light transmissive material is disposed in a manner to overlap the region surrounded by the wiring 172. The pixel electrode 176 is formed of a metal oxide having optical transparency, such as ITO and IZO (Indium Zinc Oxide) and thus basically transmits light. The pixel electrode 176 also has light reflecting properties depending on the incident angle.

The color filter substrate 162 includes: a support substrate 181 made of glass, plastic, or the like; a resin layer 182 such as a color filter layer and a black matrix layer disposed on the support substrate 181; and an opposite electrode 183 formed with optically transparent material disposed over the resin layer 182. The common electrode 183 is also formed of a metal oxide such as ITO and IZO in the same manner as the pixel electrode 176, and thus has light reflecting properties depending on the incident angle. In Embodiment 3, the reflection-preventing film 184 according to Embodiment 1 or Embodiment 2 is mounted on the display surface (observation surface) side of the color filter substrate 162. FIG. 25 shows an embodiment using the reflection-preventing film 184 according to Embodiment 1.

It is preferable in view of functionality and productivity that a lot of materials having light reflecting properties are used on the array substrate 161 and the color filter 162 as described earlier. In conventional art, the above-described reflection inside the display device has not attracted attention. However, in the case of a display device having a structure for reducing surface reflection such as moth-eye structure, light reflection on the ITO or the like may cause reflection of image in the display screen.

As shown in FIG. 25, external light incident on the LCD of Embodiment 3 is separated, upon coming into the surface of the LCD, into a component 191 which reflects on the surface of the LCD (surface of the reflection-preventing film) and a component 192 which passes through the reflection-preventing film 184 and proceeds into the LCD. In the LCD according to Embodiment 3, the reflection-preventing film disposed on the surface of the display device has a moth-eye structure. Therefore, most of the incident light passes through the reflection-preventing film 184, and the portion of the light component 191 which reflects on the surface of the LCD is separated into plurality of components due to the function of the scattering uneven structure.

The component 192 proceeding into the LCD reflects on the electrode and the wiring provided inside the display device, such as the surface of the common electrode (ITO) 183 provided in the color filter substrate 162 and the surface of the TFT 174, and then proceeds to the side of the display surface. However, since the LCD according to Embodiment 3 is designed in a manner that a half-value angle of transmission scattering intensity distribution of light transmitted through overlapped two sheets of the reflection-preventing film is 1.0° or more, the light reflected inside the display device can be scattered, thereby reducing the influence on the display. As a result, an excellent display quality with little image reflection can be achieved.

Meanwhile, in the case that the display device according to Embodiment 3 is a liquid crystal display device, it is possible to further improve the scattering properties by mixing transparent beads as described in Embodiment 2 in an adhesive for attaching the polarizer and the glass substrate in the device. This arrangement makes it possible to more precisely control the half-value angle of transmission scattering intensity distribution.

The display device according to Embodiment 3 may be used not only for the foregoing LCD but for any display device such as CRT, PDP, and EL as well, and can reduce influence of reflection in members including materials having light reflecting properties used for wiring, electrodes and the like.

The present application claims priority under the Paris Convention and the domestic law in the country to be entered into national phase on Patent Application No. 2008-138458 filed in Japan on May 27, 2008, the entire contents of which are hereby incorporated by reference.

### BRIEF DESCRIPTION OF DRAWINGS

FIG. 1 is a cross-sectional view schematically showing a reflection-preventing film according to Embodiment 1.

FIG. 2 is a cross-sectional view showing a moth-eye structure of the reflection-preventing film according to Embodiment 1. FIG. 2(a) shows the view when the unit structure of the moth-eye structure is a cone, and FIG. 2(b) shows the view when the unit structure of the moth-eye structure is a quadrangular pyramid.

FIG. 3 is a cross-sectional view showing a principle of how a moth-eye. structure achieves low reflection. FIG. 3(a) shows a cross-sectional structure of a reflection-preventing film, and FIG. 3(b) shows the refractive index of light incident on the reflection-preventing film.

FIG. 4 is an enlarged perspective view showing a scattering uneven structure of the reflection-preventing film according to Embodiment 1.

FIG. 5 is an enlarged perspective view showing anodized porous alumina.

FIG. 6 is a cross-sectional view schematically showing a production flow of anodized porous alumina. In FIG. 6, (a) to (g) show respective production steps.

FIG. 7 shows a cross-sectional view schematically showing shapes of micropores to be formed when the above steps are repeated several times with the amount of pore formation (depth direction) and the amount of etching (width direction) kept constant. FIG. 7(a) is a view showing the shape of the micropore transcribed in a graph, and FIG. 7(b) is a perspective cross-sectional view of the micropores.

FIG. 8 is a cross-sectional view schematically showing steps for imprinting the uneven surface shape of a mold on a layer.

FIG. 9 shows electron micrographs of the uneven structure of the surface of the mold used to produce the reflection-preventing film in Example 1. FIG. 9(a) is a front view, FIG. 9(b) is a perspective view, and FIG. 9(c) is a cross-sectional view.

FIG. 10 is a graph showing the refractive indexes of the surface of the reflection-preventing film in Example 1 and the surface of the reflection-preventing film in Comparative Example 1.

FIG. 11 is a photograph showing the level of reflection of a fluorescent lamp when the reflection-preventing films in Example 1 and Comparative Example 2 were used.

FIG. 12 is a schematic view showing scattering of light that penetrates overlapped two sheets of the reflection-preventing film.

FIG. 13 is a schematic view showing scattering of light after having been reflected by a reflector located below the reflection-preventing film.

FIG. 14 is a cross-sectional view showing a sample 1 formed by overlapping two sheets of reflection-preventing films.

FIG. 15 is a graph showing the angle dependence of the transmitting light intensity when using overlapped two sheets of the reflection-preventing film in Example 1 and overlapped two sheets of the reflection-preventing film in Comparative Example 2.

FIG. 16 is a graph showing the angle dependence of the reflected light intensity in a liquid crystal display device equipped with the reflection-preventing film of Example 1.

FIG. 17 is a graph showing the angle dependence of the transmitting light intensity of light which penetrates through a sample 3, a sample 4, and a sample 5 produced in Evaluation Test 2.

FIG. 18 is a graph showing measured values of the tilt angle distribution (occupancy of tilt angles) of the sample 3, sample 4, and sample 5 prepared in the evaluation test 2.

FIG. 19 is a graph showing the variation of the brightness depending on the number of pixels. FIG. 19(a) is a liquid crystal display device to which the reflection-preventing film of Example 1 is applied. FIG. 19(b) is a liquid crystal display device to which the reflection-preventing film of Comparative Example 2 is applied.

FIG. 20 is a schematic plane view showing the unevenness formed on the surface of a reflection-preventing film.

FIG. 21 is a graph showing relationships between the number of convex portions per unit area and variation in luminescence (standard deviation).

FIG. 22 is a cross-sectional view schematically showing the reflection-preventing film according to Embodiment 2.

FIG. 23 is a graph showing the angle dependence of the reflection-preventing films in Example 7.

FIG. 24 is a graph showing the angle dependence of the reflected light intensity in a liquid crystal display device equipped with the reflection-preventing film in Example 7.

FIG. 25 is a schematic cross-sectional view of the LCD according to Embodiment 3, showing reflection of external light in the LCD.

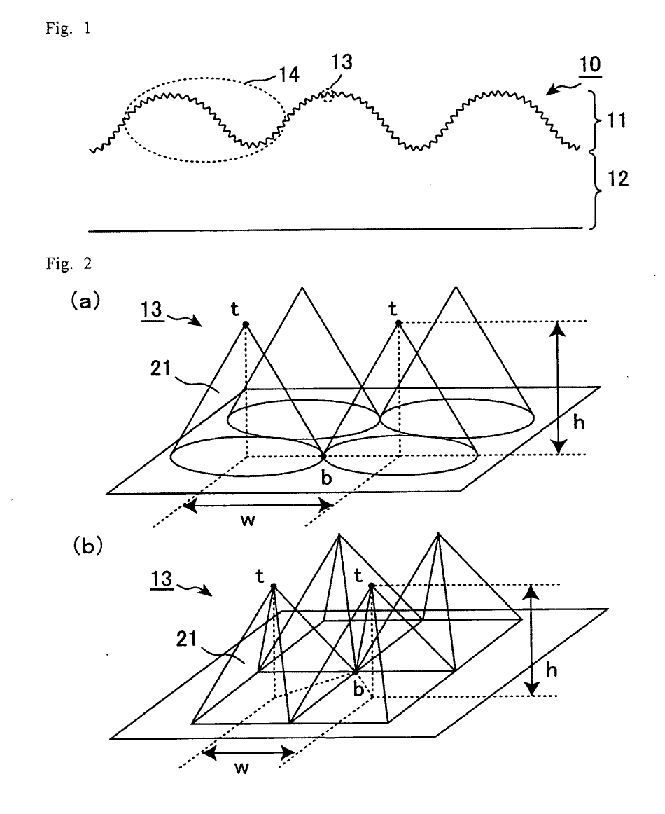

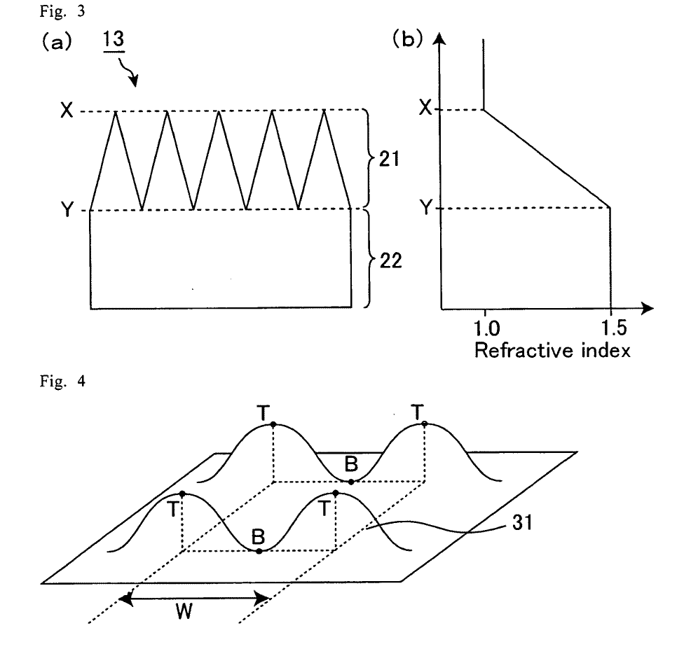

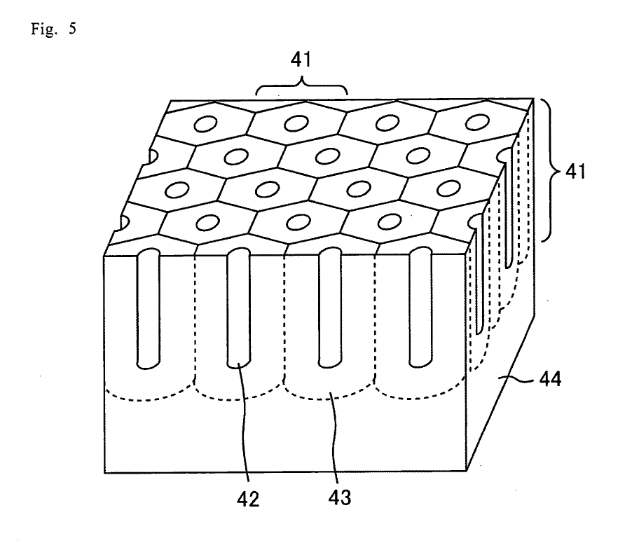

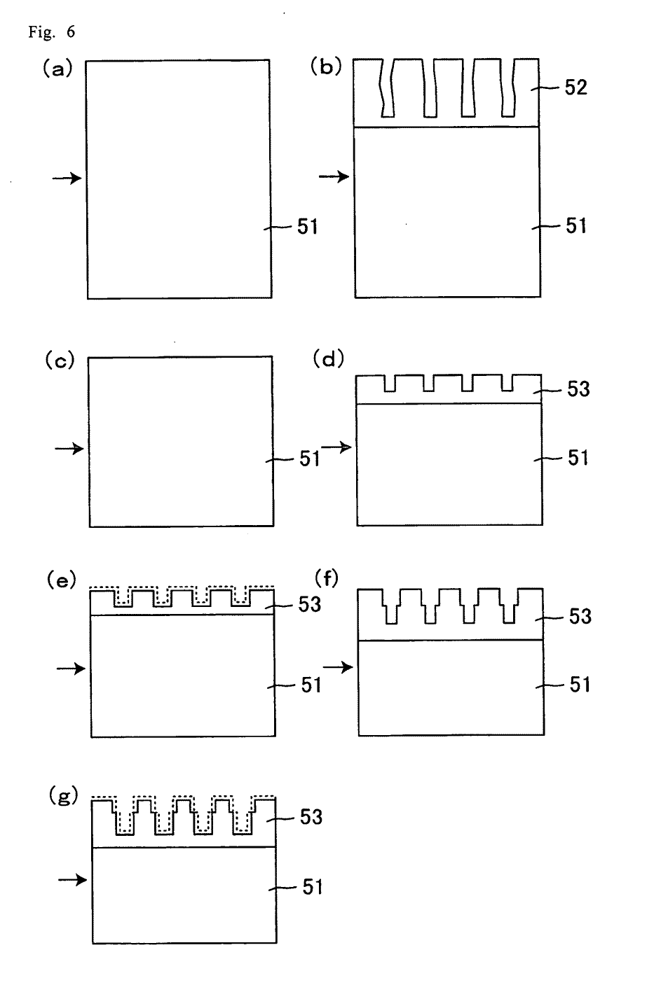

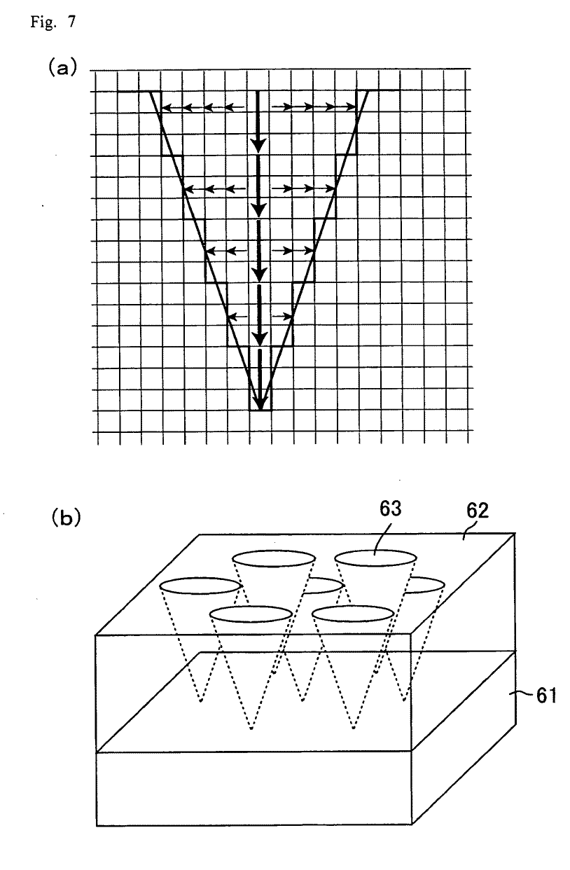

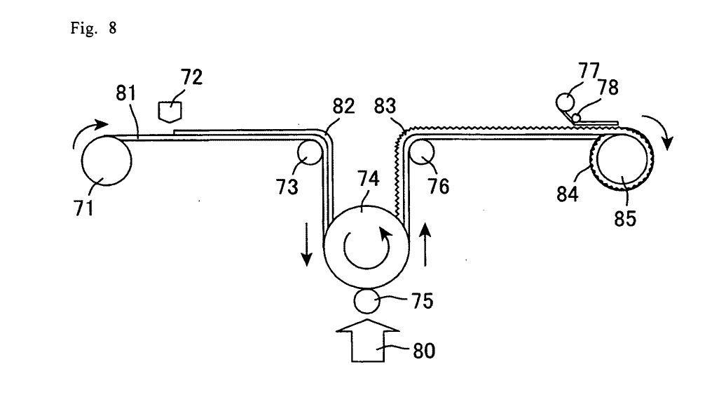

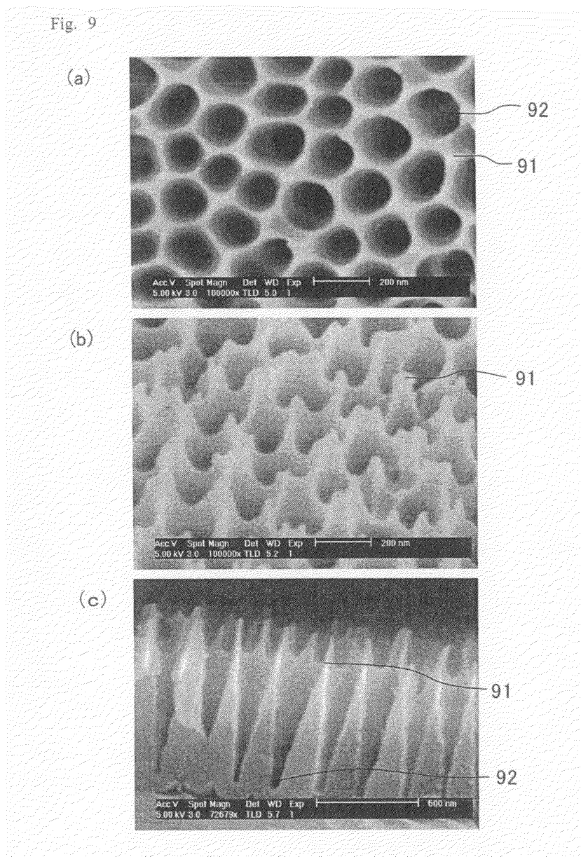

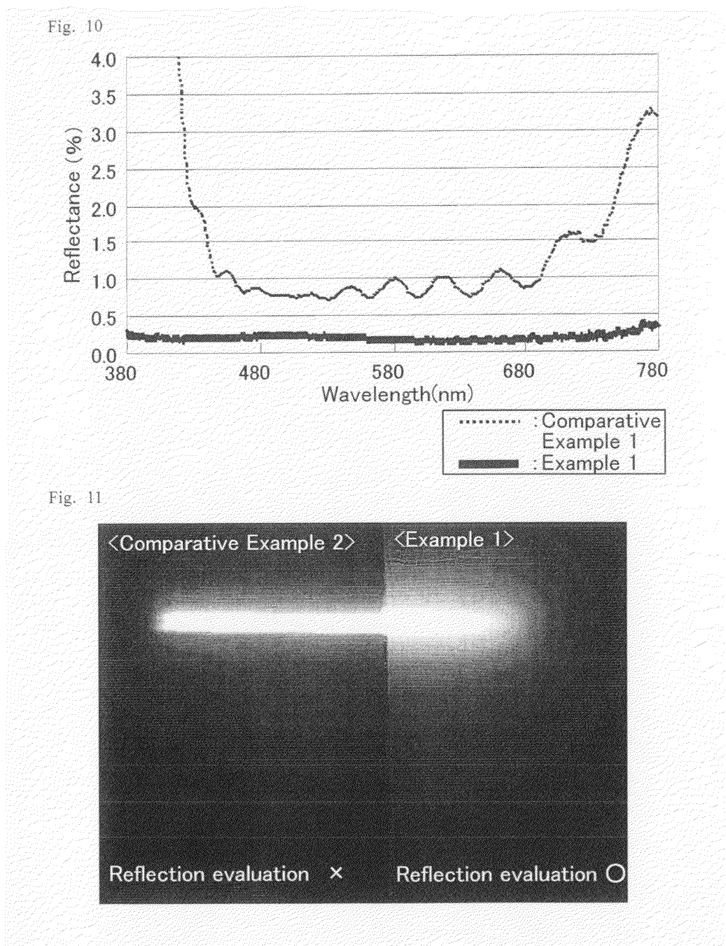

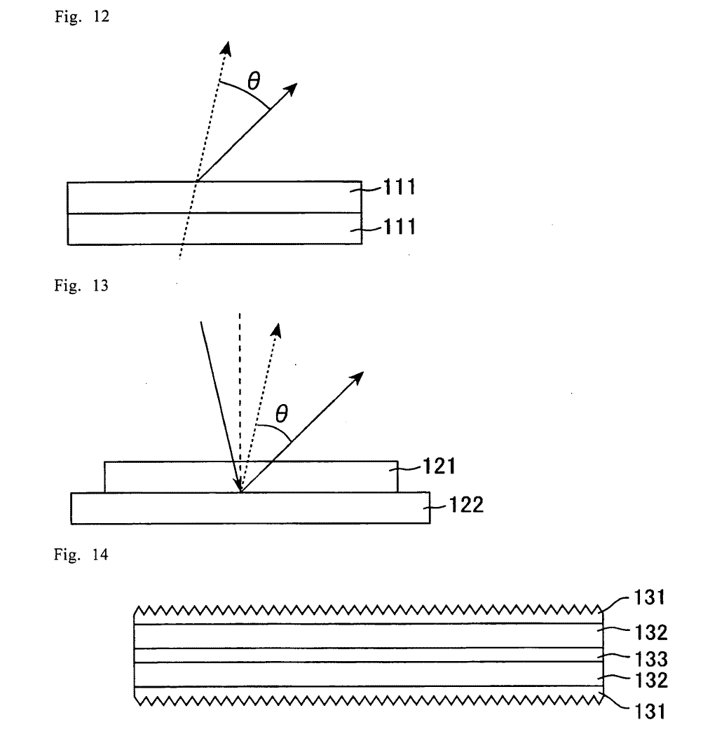

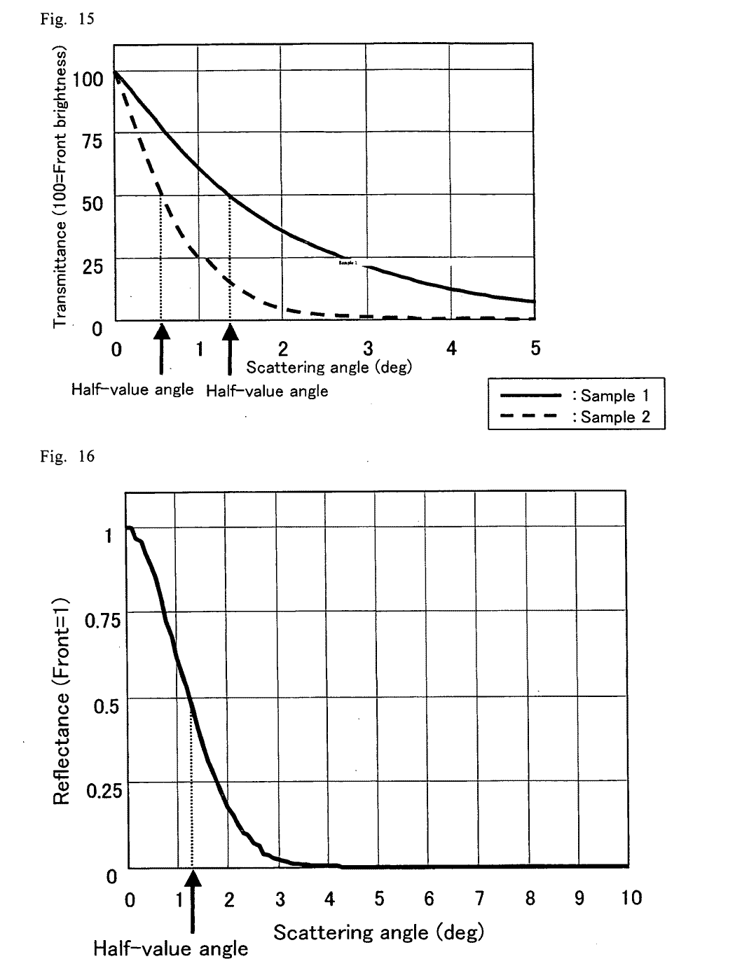

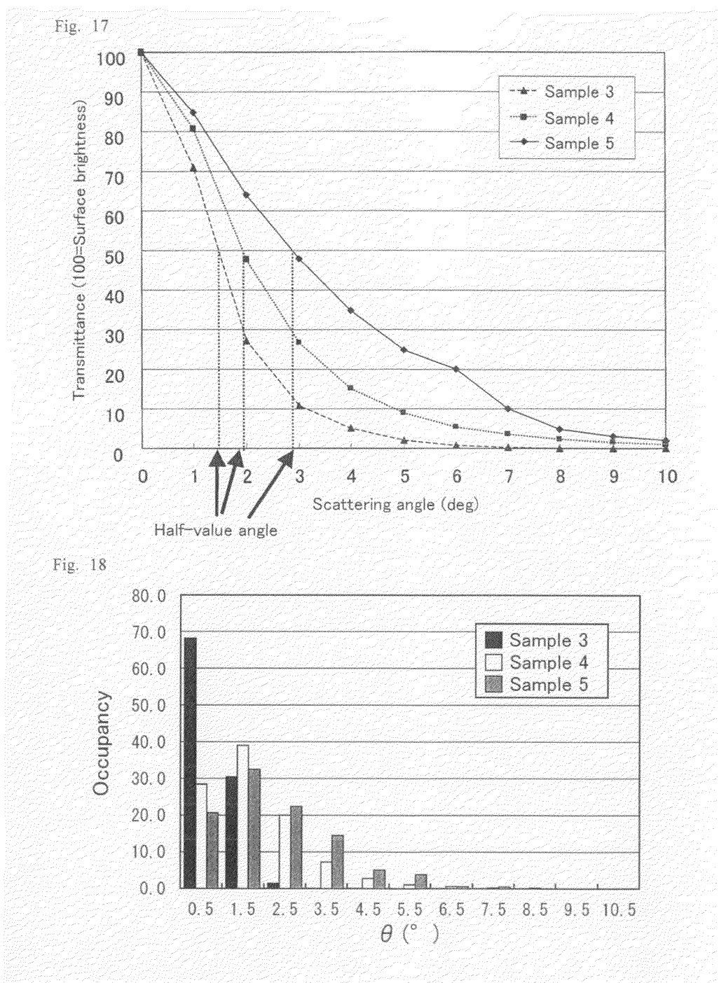

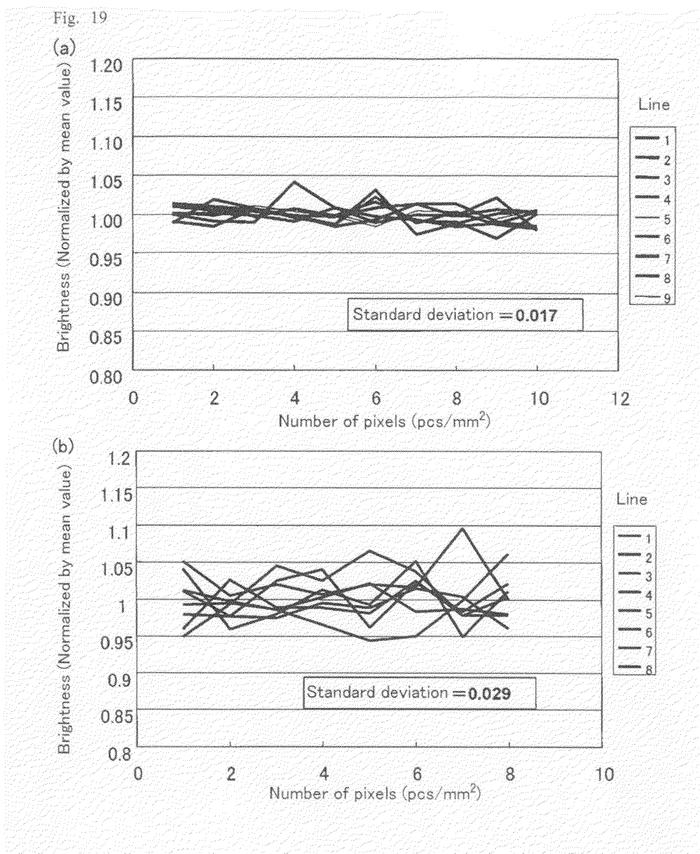

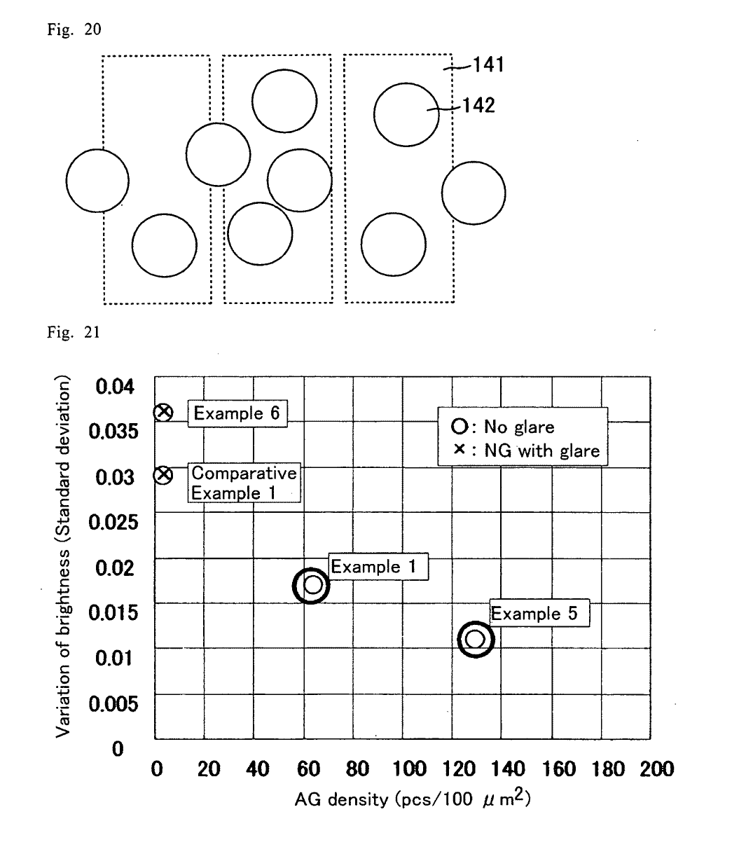

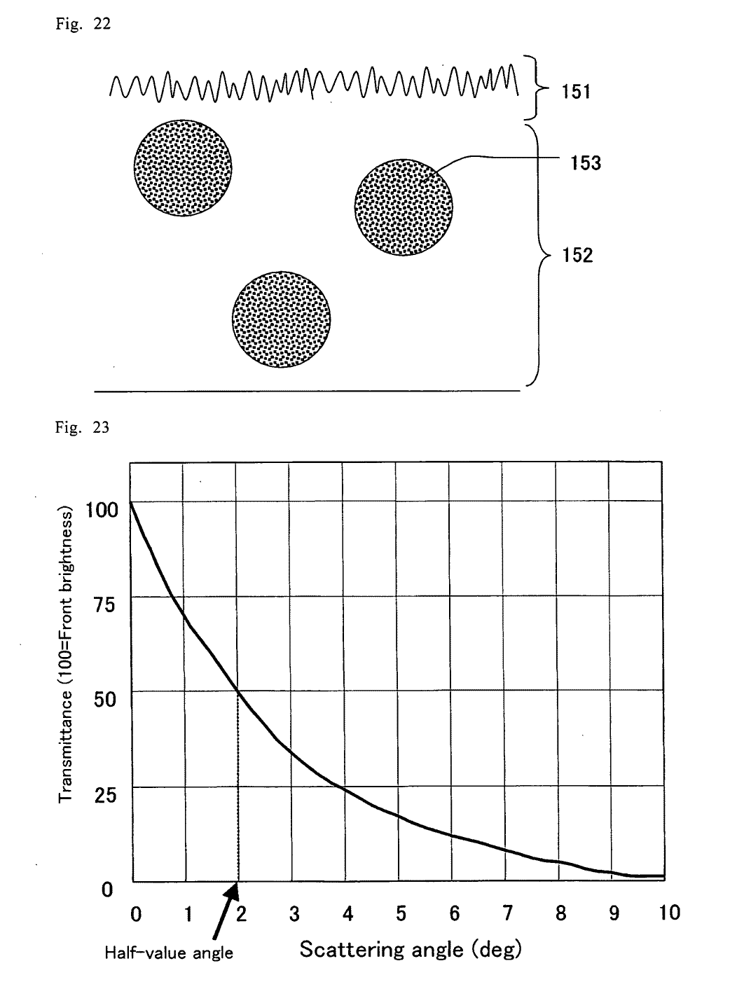

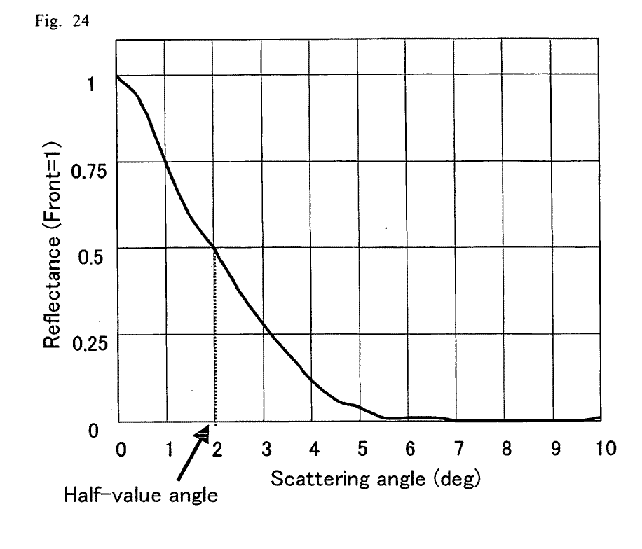

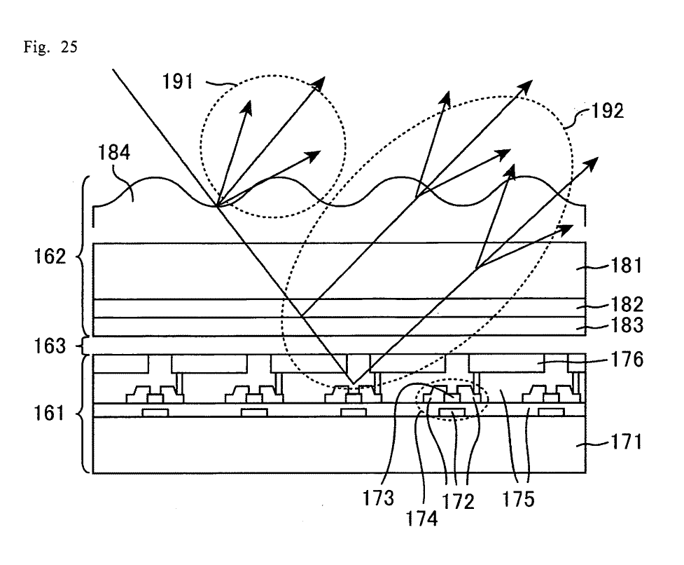

### EXPLANATION OF SYMBOLS

10, 184: reflection-preventing film
11: surface layer
12: foundation layer
13: first uneven structure, fine uneven structure, moth-eye structure
14: second uneven structure, scattering uneven structure
21: convex portion (moth-eye structure)
22: foundation portion
31: convex portion (scattering uneven structure)
41: cell
42, 63: micropores
43: barrier layer
44, 51, 61: aluminum substrate
52: porous alumina layer (first porous alumina layer)
53: porous alumina layer (second porous alumina layer)
62: porous alumina layer
71: base member film roll
72: die coater
73, 75, 76, 78: pinch roll
74: mold roll
77: lamination film roll
80: curing treatment
81: base member film
82: (coated) resin coat
83: (uneven) resin coat
84: lamination film
85: multilayer film roll
91: convex portion (mold)
92: concave portion (mold)
111, 121, 131: reflection-preventing film
122: reflector
132: TAC film
133: glass
141: unit area
142: convex portion (scattering uneven structure)
151: surface layer
152: foundation layer
153: transparent beads
161: array substrate
162: color filter substrate
163: liquid crystal layer
171: support substrate (on the side of array substrate)
172: electrode
173: semiconductor layer
174: TFT
175: insulation interlayer
176: picture electrode
181: support substrate (on the side of color filter substrate)
182: resin layer
183: counter electrode
191: external light (components reflecting on the surface of LCD)
192: external light (components traveling into LCD)

1. A reflection-preventing film having on its surface a fine uneven structure in which a width between adjacent top points is equal to or less than a visible wavelength,
wherein a half-value angle of transmission scattering intensity distribution of light transmitted through overlapped two sheets of the reflection-preventing film is 1.0° or more.

2. The reflection-preventing film according to claim 1,
wherein the half-value angle is 2.8° or less.

3. The reflection-preventing film according to claim 1, which has a refractive index different from that of a main component of the reflection-preventing film, and comprises scatterers each having a particle size of 1 μm or more.

4. The reflection-preventing film according to claim 3,
wherein the scatterers are irregularly disposed with a distance of 1 μm or more between each other.

5. The reflection-preventing film according to claim 1, further having on its surface an uneven structure in which a width between adjacent top points is 1 μm or more.

6. The reflection-preventing film according to claim 3,
wherein the number of convex portions per 100 μm² of the uneven structure is 60 or more.

7. A display device having on its display surface the anti-reflective surface according to claim 1.
